(19) United States
(12) Patent Application Publication
(10) Pub. No.: US 2005/0227743 A1
(43) Pub. Date: Oct. 13, 2005

(54) Method and device for receiving radio signal

(75) Inventor: Yoshihiro Kubo, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, TOKYO (JP)

(21) Appl. No.: 10/519,834

(22) PCT Filed: Aug. 20, 2002
(86) PCT No.: PCT/JP02/08363

§ 371 Date: Jan. 11, 2005

(51) Int. Cl. H04B 1/38

(52) U.S. Cl. 455/574; 455/572

(57) ABSTRACT

In a wireless signal receiving method in which after a physical channel sent from a base station in a wireless communication system at an unspecified timing is demodulated from a high frequency signal to a baseband signal, the baseband signal is decoded and is outputted as a decoded baseband signal, and a desired channel included in the decoded baseband signal is decrypted by a communication control part (13) for performing communication control, this invention is the wireless communication receiving method being characterized by comprising a judgment step of judging whether or not the desired channel exists in the physical channel of the decoded baseband signal and outputting a judgment result, a wake-up step of bringing a power source of the communication control part (13) into an ON state in a case where the judgment result indicates existence of the desired channel, and a sleep step of bringing the power source of the communication control part into an OFF state when it is confirmed that the communication control part does not need to be operated in a case where the power source of the communication control part (13) is in the ON state, and thus electric power consumed by a mobile station can be saved.

### TECHNICAL FIELD

The present invention relates to a receiving method and receiving apparatus of a wireless signal used in a wireless communication system such as, for example, a WCDMA system.

### BACKGROUND ART

Conventionally, there is a technique disclosed in JP-B-7-22271.

The conventional technique disclosed in JP-B-7-22271 will be described.

According to this conventional technique, in the case where a receiving apparatus is waiting for a call signal PAGE, a part of a mobile station, such as a signal processing circuit, is intermittently operated, and the electric power consumption of the mobile station can be saved.

However, the conventional technique to intermittently operate the part of the mobile station is used only in the case of waiting for a signal sent at a specified timing, such as the call signal PAGE, and there has been a problem that in the case where the mobile station is waiting for a signal sent at an unspecified timing, it is impossible to intermittently operate the part of the mobile station, and the electric power consumption of the mobile station can not be saved.

### DISCLOSURE OF THE INVENTION

The invention has an object to solve the above problem and to save the electric power consumption of a mobile station by intermittently operating a part of the mobile station even in the case where the mobile station is waiting for a signal sent at an unspecified timing.

In a wireless signal receiving method in which after a physical channel sent from a base station in a wireless communication system at an unspecified timing is demodulated from a high frequency signal to a baseband signal, the baseband signal is decoded and is outputted as a decoded baseband signal, and a desired channel included in the decoded baseband signal is decrypted by a communication control part for performing communication control, this invention is a wireless communication receiving method including a judgment step of judging whether or not a signal of the desired channel exists in the physical channel of the decoded baseband signal and outputting a judgment result, a wake-up step of bringing a power source of the communication control part into an ON state in a case where the judgment result indicates existence of the desired channel, and a sleep step of bringing the power source of the communication control part into an OFF state when it is confirmed that the communication control part does not need to be operated in a case where the power source of the communication control part is in the ON state.

In a wireless signal receiving method in which after a physical channel sent from a base station in a wireless communication system at an unspecified timing is demodulated from a high frequency signal to a baseband signal, the baseband signal is decoded and is outputted as a decoded baseband signal, and a desired channel included in the decoded baseband signal is decrypted by a communication control part for performing communication control, this invention is a wireless signal receiving apparatus including judgment means for judging whether or not a signal of the desired channel exists in the physical channel of the decoded baseband signal and outputting a judgment result, wake-up means for bringing a power source of the communication control part into an ON state in a case where the judgment result indicates existence of the desired channel, and sleep means for bringing the power source of the communication control part into an OFF state when it is confirmed that the communication control part does not need to be operated in a case where the power source of the communication control part is in the ON state.

According to the invention, even in the case of waiting for the physical channel sent at the unspecified timing, a part of the wireless signal receiving apparatus is intermittently operated, so that the electric power consumption of the wireless signal receiving apparatus can be saved.

### BRIEF DESCRIPTION OF THE DRAWINGS

FIG. 1 is a view showing a structure of channels in a WCDMA system.

FIG. 2 is a structural view of a mobile station of embodiment 1 of this invention.

FIG. 3 is a sequence view showing an operation of embodiment 1 of this invention.

FIG. 4 is a view showing electric power consumed by the mobile station in the case of embodiment 1 of this invention.

FIG. 5 is a flowchart view showing an operation of a main part of the invention according to embodiment 1 of this invention.

FIG. 6 is a flowchart view showing an operation of the main part of the invention according to embodiment 1 of this invention.

FIG. 7 is a flowchart showing an operation of the main part of the invention according to embodiment 1 of this invention.

FIG. 8 is a flowchart view showing an operation of a main part of the invention according to embodiment 2 of this invention.

FIG. 9 is a flowchart showing an operation of a main part of the invention according to embodiment 3 of this invention.

FIG. 10 is a flowchart view showing an operation of the main part of the invention according to embodiment 3 of this invention.

FIG. 11 is a flowchart view showing an operation of the main part of the invention according to embodiment 3 of this invention.

### BEST MODE FOR CARRYING OUT THE INVENTION

### Embodiment 1

Embodiment 1 relates to a wireless signal receiving method used in a network system of a WCDMA (Wideband Code Division Multiple Access) system and used by a mobile station. Besides, this wireless signal receiving method is the wireless signal receiving method in which electric power consumption of the mobile station can be saved in a case of waiting for an FACH (Forward Access Channel).

Incidentally, there are various scenes in which the mobile station waits for the FACH in the case where the mobile station is operating. For example, in the case where the mobile station uses a circuit switched service, a channel used by the mobile station for the circuit switched service is specified by the FACH. Accordingly, before the mobile station determines the channel used for the circuit switched service, the mobile station waits for the FACH.

Besides, also before the mobile station determines a channel used for packet switched service, the same applies.

In this embodiment, a description will be given to the wireless signal receiving method at the time when the mobile station waits for the FACH in various cases.

However, an operation at the time when the mobile station waits for the FACH in the case where the mobile station performs packet switched service, will be described in a different embodiment.

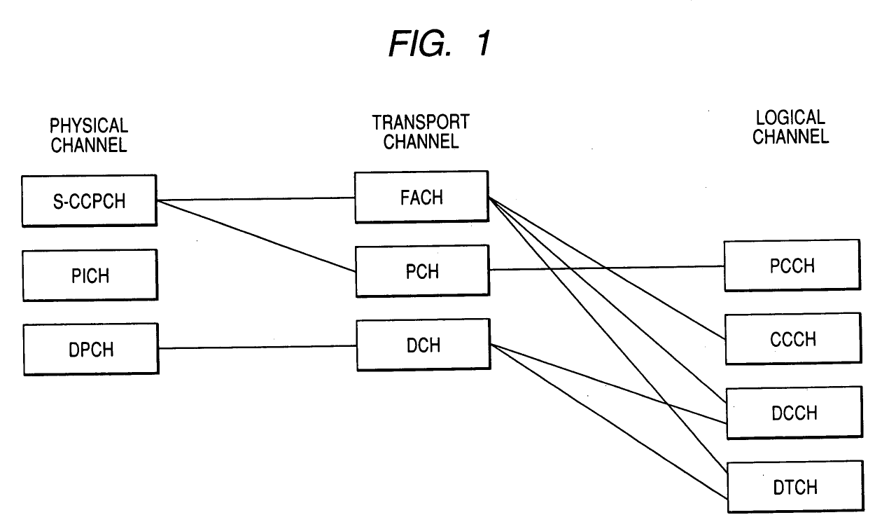

First, a channel relating to this embodiment will be described on the basis of FIG. 1.

First, the channel is hierarchically divided into a physical channel which is defined by a specific carrier frequency, scrambling code, channelization code etc, a transport channel mapped to the physical channel, and a logical channel mapped to the transport channel.

The physical channel used in this embodiment 1 or other embodiments, the transport channel corresponding to the physical channel, and the logical channel will be described on the basis of FIG. 1.

First, the correspondence between the physical channel and the transport channel will be described.

Plural transport channels are mapped into the physical channel. According to an example of FIG. 1, an FACH (Forward Access Channel) and a PCH (Paging Channel) are mapped into an SCCPCH (Secondary Common Control Physical Channel) as the physical channel.

Besides, in the case where the transport channel is mapped to the physical channel, multiplexing is performed for every several transport channels, and the multiplexed signal is mapped to the physical channel.

Incidentally, a coded signal in which plural transport channels are multiplexed is called a CCTRCH (Coded Composite Transport Channel). Besides, the physical channel can include plural CCTRCHs.

Next, the correspondence between the transport channel and the logical channel will be described.

According to the example of FIG. 1, a CCCH (Common Control Channel), a DCCH (Dedicated Control Channel), and a DTCH (Dedicated Traffic Channel) are mapped into the FACH as the transport channel. A PCCH (Paging Control Channel) is mapped into a PCH (Paging Channel). The DCCH (Dedicated Control Channel) and the DTCH (Dedicated Traffic Channel) are mapped into a DCH (Dedicated Channel). The detailed description of the respective channels will be described later as the need arises.

Next, a description will be given to a case where the channel is divided according to usage.

An individual channel is a channel in which one channel (physical channel, transport channel or logical channel) is used between a base station and a mobile station in one-to-one relation. When the dedicated channel is used, transmission of a large amount of information is possible.

A common channel is a channel in which one channel is used between a base station and a mobile station in one-to-plural relation. The common channel is used in a case where not a very large amount of information is transmitted. Besides, since the channel can be used efficiently, the channel contributes to improvement in efficiency of an occupied band.

Besides, with respect to the channel, there is a case where it is expressed as a packet switched channel, a circuit switched channel or a control channel, and these channels are irrelevant to the distinction between the dedicated channel and the common channel, and the distinction between the physical channel, the transport channel and the logical channel. Besides, a channel is determined to be one of the packet switched channel, the circuit switched channel and the control channel according to whether it is used for use of packet switched service, circuit switched service or control.

Next, among specific channels used for the WCDMA system, channels related to this embodiment 1 will be described.

The SCCPCH is one of physical channels, and one of common channels. Besides, it is a channel in which a signal for controlling a mobile station or a signal of a channel for packet switched service, which is a signal with small communication traffic volume, is carried. Besides, the SCCPCH is a channel sent at an unspecified time.

The FACH is one of transport channels mapped to the SCCPCH.

A PICH (Paging Indicator Channel) is one of physical channels. Besides, it is a channel corresponding to the SCCPCH in one-to-one relation, and by decrypting the PICH, it is possible to understand whether or not an incoming call to the mobile station occurs. Besides, the PICH is a physical channel sent at a specified timing.

Next, a state between the base station and the mobile station is divided into three states in view of occupied band or electric power consumption, and they will be defined. A state in which the physical channel, the transport channel or the logical channel used by the mobile station is the dedicated channel is made an “dedicated state”.

A state (except a waiting state described later) in which the physical channel, the transport channel or the logical channel used by the mobile station is the common channel is made a “common state”.

Besides, even if the physical channel, the transport channel or the logical channel is the common channel, in the case where circuit switched service or packet switched service does not exist between the base station and the mobile station, in principle, only when the PICH (Paging Indicator Channel) is sent, the mobile station intermittently brings a part of a receiving device into a power ON state, and waits for the PICH. Hereinafter, the state in which the mobile station 1 intermittently waits for the PICH is made a “waiting state”.

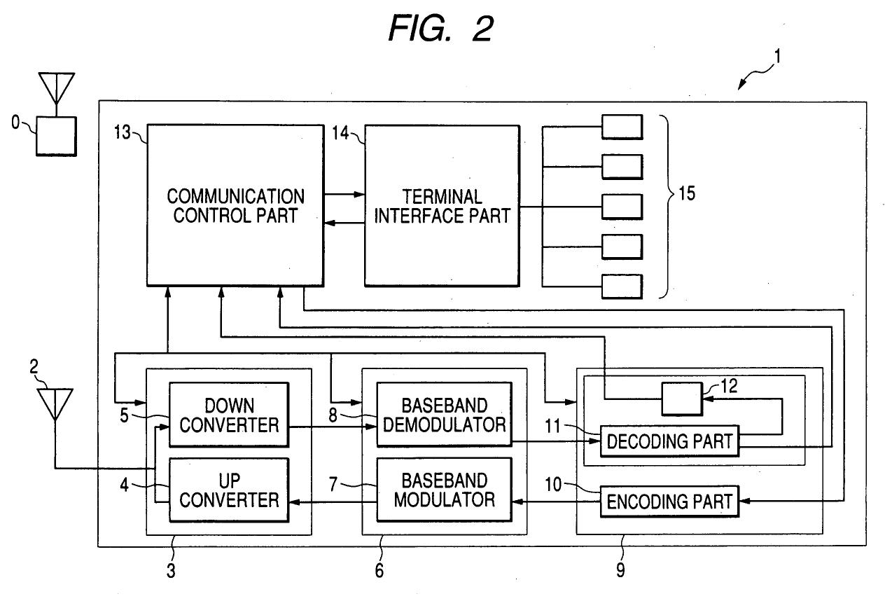

A structure of a mobile station including a receiving method or a receiving apparatus of embodiment 1 of this invention will be described on the basis of FIG. 2.

Reference numeral 0 denotes a base station used in a wireless system; 1, a mobile station used in this embodiment 1; 2, an antenna provided in the mobile station 1; and 3, a wireless part connected to the antenna 2 and including an up converter 4 and a down converter 5. Reference numeral 6 denotes a baseband modulation/demodulation part connected to the wireless part 3, which includes a baseband modulation part 7 and a baseband demodulation part 8. Reference numeral 9 denotes a communication channel encoding part connected to the baseband modulation/demodulation part 6, which includes a decoding part 10, an encoding part 11 and a desired channel existence judgment part 12.

The desired channel existence judgment part 12 is a portion for judging whether or not a desired transport channel is included in the CCTRCH as a signal which is encoded and in which plural transport channels are multiplexed. In the case where the judgment result indicates that the desired transport channel is included in the CCTRCH, a signal is outputted which indicates that the desired transport channel exists in the CCTRCH. Reference numeral 13 denotes a communication control part connected to the communication channel encoding part 9; 14, a terminal IF (Inter Face) part connected to the communication control part; and 15, various terminals, such as a MIC and a speaker, connected to the terminal IF part 14. Besides, the mobile station 1 includes a timing control part (not shown). The timing control part is a circuit which supplies electric power to the respective blocks in the inside of the mobile station, and time-manages the control.

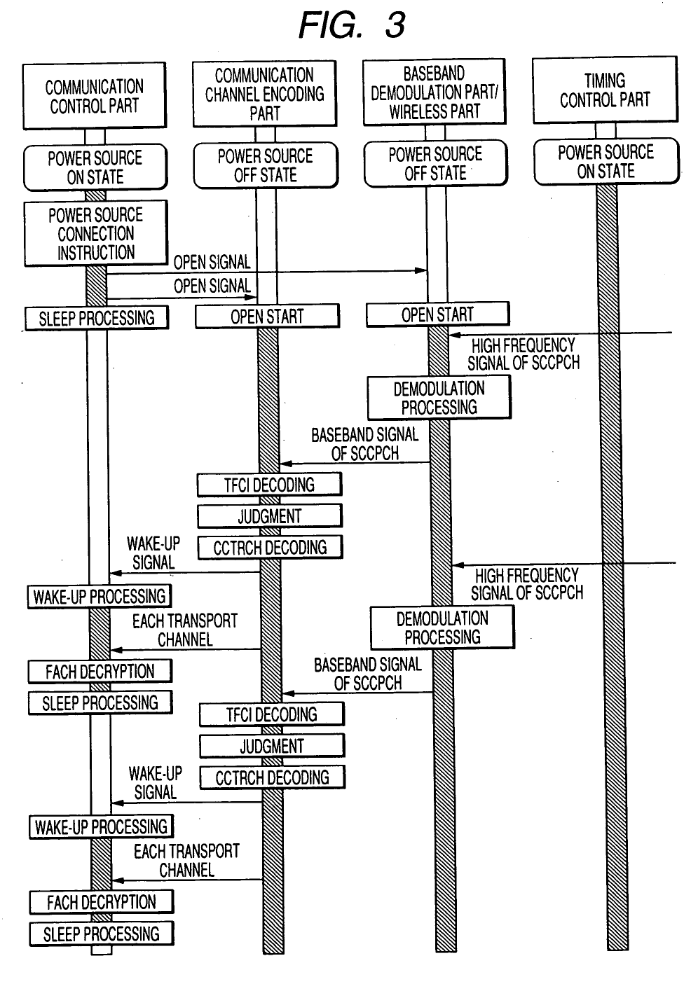

Next, in this embodiment, the operation performed by the respective devices provided in the mobile station 1 in the case of waiting for the FACH will be described on the basis of FIG. 3.

In FIG. 3, with respect to each of the communication control part 13, the communication channel encoding part 9, the baseband modulation/demodulation part 6, and the wireless part 3 or timing control part (hereinafter referred to as “respective parts”), a time axis indicating the passage of time is depicted in the vertical direction, and the operations performed by the respective parts are expressed in the passage of time.

A solidly shaded portion in the time axis means that the power source is in the ON state in that portion, and an outline portion in the time axis means that the power source is in the OFF state in that portion.

In the drawing, first, in the case where the communication control part 13 is in the power ON state, and when the communication channel encoding part 9, the baseband modulation/demodulation part 6 or the wireless part 3 is in the power OFF state, an OPEN signal is outputted from the communication control part 13 so that the communication channel encoding part 9, the baseband modulation/demodulation part 6 or the wireless part 3 is brought into the power ON state.

Besides, this OPEN signal is inputted to the communication channel encoding part 9, the baseband modulation/demodulation part 6 or the wireless part 3, and the communication channel encoding part 9, the baseband modulation/demodulation part 6 or the wireless part 3 is brought into the power ON state.

Next, in the case where the communication channel encoding part 9, the baseband modulation/demodulation part 6 and the wireless part 3 are in the power ON state, and when the communication control part 13 does not receive a necessary operation request, a request to stop the supply of electric power to the communication control part 13 is made to the timing control part (not shown), and the communication control part 13 is brought into a sleep state.

On the other hand, in the case where the wireless part 3 is in the power ON state, and when a high frequency signal of the SCCPCH is inputted to the wireless part 3, the SCCPCH is converted into an intermediate frequency signal, and is inputted to the baseband modulation/demodulation part 6. The intermediate frequency signal inputted to the baseband modulation/demodulation part 6 is converted into a baseband signal, and is inputted to the communication channel encoding part 9.

The communication channel encoding part 9 judges, on the basis of the inputted baseband signal, whether or not the FACH exists in the SCCPCH.

After the judgment, the communication channel encoding part 9 decodes the baseband signal.

In the case where the baseband signal is decoded into the decoded baseband signal, the communication channel encoding part 9 sends a wakeup signal to the communication control part 13.

Here, although the baseband signal is decoded after the judgment, there is also a case where the baseband signal is decoded before the judgment.

In the case where the wakeup signal is inputted to the communication control part 13, the communication control part 13 is brought into the power ON state.

In the case where the communication control part 13 is in the power ON state, the communication channel encoding part 9 outputs the decoded baseband signal to the communication control part 13.

In the case where the communication control part 13 is in the power ON state, and when the decoding baseband signal is inputted from the communication channel encoding part 9 to the communication control part 13, the communication control part 13 selects the FACH among plural transport channels included in the inputted decoded baseband and decrypts it.

In the case where the communication control part 13 completes the decryption of the FACH, and when the communication control part 13 does not receive a necessary operation request, the communication control part 13 requests the timing control part to stop the supply of electric power to the communication control part 13, and the communication control part 13 is brought into a sleep state. Subsequently, each time the SCCPCH of the high frequency signal is inputted to the wireless part 3, a similar operation is repeated.

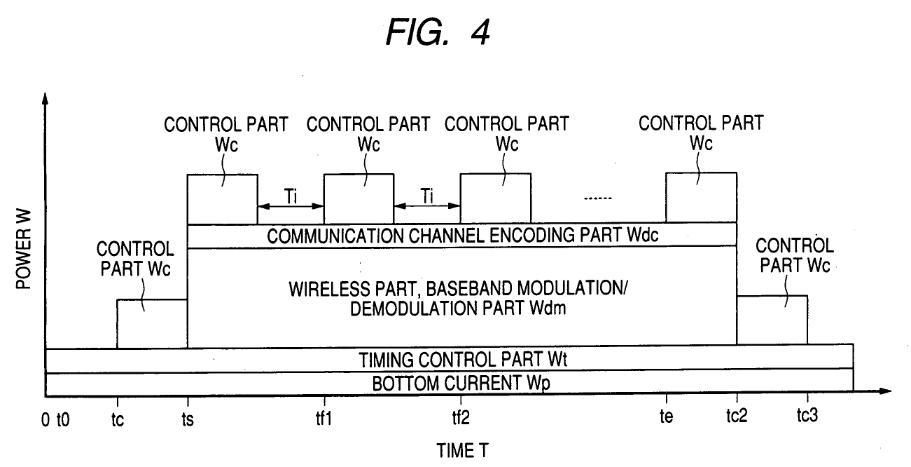

Next, in the case of the embodiment as stated above, the state of electric power consumed by the mobile station 1 will be described on the basis of FIG. 4.

FIG. 4 is a view showing electric power consumed by the respective parts of the mobile station 1.

The horizontal axis of FIG. 4 indicates time T, and the vertical axis indicates electric power W.

A bottom current is a current, such as an LSI standby current, consumed in the case where all functions of the mobile station 1 are stopped, and electric power Wp is consumed. The timing control part always consumes electric power, and consumes electric power Wt. The communication control part 13 consumes electric power Wc. The wireless part 3 and the baseband modulation/demodulation part 6 consume electric power Wdm. The communication channel encoding part 9 consumes electric power Wdc. Besides, electric power consumed by the mobile station 1 is made W.

It is assumed that the mobile station 1 is in the power OFF state during a period from time T0 to time Tc1. At this time, since the electric power W consumed by the mobile station 1 is the bottom current and the electric power consumption of the timing control part, the electric power W consumed by the mobile station 1 can be expressed as follows.
T0≦T<Tc1
W=Wp+Wt (1)

It is assumed that the mobile station 1 is brought into the power ON state at time Tc1, and the mobile station 1 starts to receive the SCCPCH at time Ts. During a period from time Tc1 to time Ts, in the mobile station 1, in addition to the bottom current and the electric power consumed by the timing control part Wp and Wt, the communication control part 13 consumes the electric power Wc. Accordingly, in the case where the mobile station 1 is brought into the power ON state, the electric power W consumed by the mobile station 1 is expressed as follows.
Tc1≦T<Ts
W=Wp+Wt+Wc (2)

It is assumed that from time Ts, the power source of the wireless part 3, the baseband modulation/demodulation part 6 and the communication channel encoding part 9 is connected, the mobile station 1 starts to receive the signal of the SCCPCH, and the mobile station 1 ends the reception of the SCCPCH at time Te. Besides, electric power consumed by the wireless part 3 or the baseband modulation/demodulation part 6 is made Wdm. Besides, it is assumed that the communication control part 13 decrypts the signal of the FACH at time Tfn (n is a natural number), and a period in which the mobile station 1 can receive the signal of the SCCPCH and the signal of the FACH is not decrypted is made Ti. Then, an expression can be expressed as follows.
Ts≦T<Te (except the period of Ti)
W=Wp+Wt+Wdm+Wdc+Wc (3)
Ts≦T<Te (limited to the period of Ti)
W=Wp+Wt+Wdm+Wdc (4)

It is assumed that at time Te, the communication control part 13 determines to end the waiting for the FACH, and at time Tc2, the power source of the wireless part 3, the baseband modulation/demodulation part 6 and the communication channel encoding part 9 is turned off. Then, an expression can be expressed as follows.
Te≦T<Tc2
W=Wp+Wt+Wdm+wdc+Wc (5)

In a period from time Tc2 to time Tc3 when the power source of the communication control part 13 is turned off, electric power consumed by the mobile station 1 can be expressed as follows.
Tc2≦T<Tc3
W=Wp+Wt+Wc (6)

Subsequently to time Tc3, when the power source of the mobile station 1 is not connected, the electric power consumed by the mobile station 1 can be expressed as follows.
T≧Tc3
W=Wp+Wt (7)

According to this embodiment, each time a section of Ti occurs in the period in which time T elapses from time Ts to time Tc2, the electric power can be saved. Accordingly, in the section from Ts to Tc2, as the ratio R of the total of the sections of Ti becomes high, the electric power of the mobile station 1 is more saved. The ratio R is expressed by an expression as follows.
R=ΣTi/(Tc2−Ts) (8)

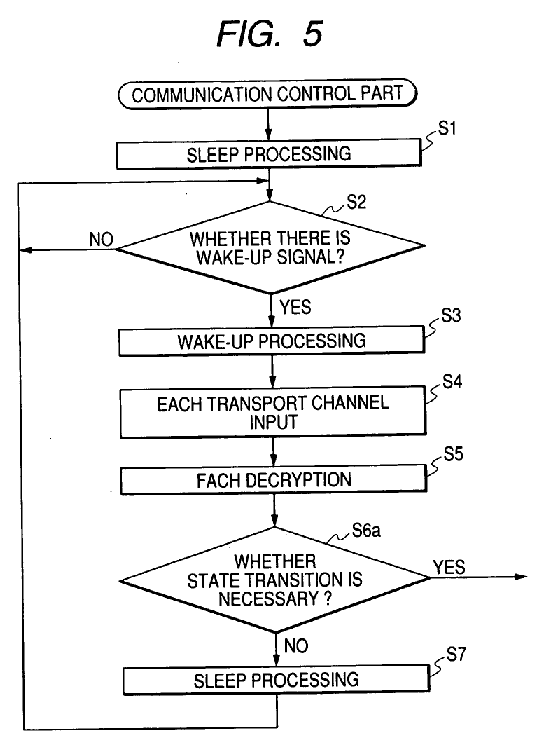

Next, in this embodiment 1, a specific operation of the communication control part 13 in the case of waiting for the FACH will be description on the basis of FIG. 5.

Step S1 is a sleep process in which in the case where the mobile station 1 determines to wait for the FACH, and when the communication control part 13 is in the power ON state, after the communication control part 13 confirms whether or not the communication control part 13 needs to be operated, the communication control part 13 is brought into the power OFF state.

Step S2 is a process in which in the case where the communication control part 13 is in the power OFF state, the communication control part 13 waits for a signal (hereinafter referred to as a “wake-up signal”) to bring the communication control part 13 into the power ON state.

The wake-up signal is, for example, a signal which is outputted by the communication channel encoding part 9 in the case where decoding of the baseband signal is completed, or a signal at a time when the baseband modulation/demodulation part 6 or the wireless part 3 reports a monitor result of a peripheral cell. Alternatively, a cell search is performed by the baseband modulation/demodulation part 6, and in the case where the communication control part 13 performs a communication control operation on the basis of the result of the cell search, it may be a signal or the like by which the baseband modulation/demodulation part 6 informs the communication control part 13 about the result of the cell search. Besides, when there is a signal outputted in the case where the operation of the communication control part 13 is needed, it is desirable that the signal is also made the wake-up signal.

In this process, in the case where the wake-up signal is inputted to the communication control part 13, the procedure proceeds to a next step. On the other hand, when the wake-up signal is not inputted to the communication control part 13, this state continues.

Step S3 is a wake-up process in which in the case where the wake-up signal is inputted to the communication control part 13, the communication control part 13 is brought into the power ON state.

Step S4 is a process in which when the communication control part 13 is in the power ON state, the decoded baseband signal is inputted from the communication channel encoding part 9 to the communication control part 13. Incidentally, the baseband signal inputted at this step is plural transport channels separated from the CCTRCH.

Step S5 is a process in which among the plural transport channels inputted to the communication control part 13, the communication control part 13 selects the FACH and decrypts the FACH.

Step S6a is a process in which it is judged from the decryption result of the FACH at step S5 whether or not the operation of the communication control part 13 needs to perform a state transition from the operation of FIG. 5.

In this embodiment, that it is necessary to perform the state transition means a case where the decryption result indicates the necessity to change the channel used by the mobile station.

Step S7 is a sleep process in which after step S6a, in the case where it is confirmed that the communication control part 13 does not need to be operated, the communication control part 13 is brought into the power OFF state.

After the power source of the communication control part 13 is turned off, the communication control part 13 waits for the input of the wake-up signal again.

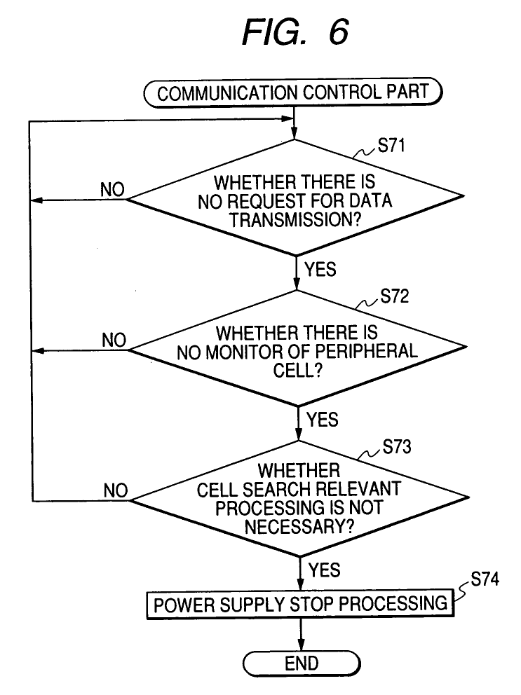

Next, an operation example of the sleep process at step S1 or step S7 will be described by use of FIG. 6.

Step S71 is a process in which it is confirmed whether or not a request for transmission of data is issued from the terminal IF part 14 to the communication control part 13. In the case where there is no request for the transmission of data from the terminal IF part 14 to the communication control part 13, the procedure proceeds to step S72.

Step S72 is a process in which it is confirmed whether or not the communication control part 13 needs to monitor a peripheral cell. In the case where the communication control part 13 does not need to monitor the peripheral cell, the procedure proceeds to step S73.

Step S73 is a process in which it is judged whether or not it is necessary to perform a cell search relevant processing in the communication control part 13. Here, the cell search relevant processing means such a processing that the baseband modulation/demodulation part 6 makes a cell search, and in the case where the communication control part 13 grasps the period when this cell search is carried out, the communication control part 13 instructs the baseband modulation/demodulation part 6 to make the cell search each time the period passes, or the communication control part 13 performs the communication control operation on the basis of the cell search result of the baseband modulation/demodulation part 6. In the case where the communication control part 13 does not need to perform the cell search relevant processing, the procedure proceeds to step S74.

At step S71 to step S73, in the case where it is impossible to proceed to the next step, the procedure returns to step S71.

Step S74 is a process in which the communication control part 13 requests the timing control part to stop the supply of electric power to the communication control part 13, and stops the supply of electric power to the communication control part 13.

Instead of the processing of actually bringing the power source of the communication control part 13 into the OFF state, the processing of stopping the supply of electric power to the communication control part 13 may be made a processing of stopping a clock supplied to the communication control part 13.

In the case where the processing of bringing the power source of the communication control part 13 into the OFF state is replaced by the processing of stopping the clock supplied to the communication control part 13, the processing of bringing the power source of the communication control part 13 into the ON state has only to be replaced by a processing of starting the supply of the clock to the communication control part 13.

Incidentally, steps S71 to S73 are the steps in which it is confirmed whether or not the communication control part 13 needs to be operated, and the order of the processes from step S71 to step S73 is not critical. Besides, in the case where there can occur an operation request for the communication control part 13, it is desirable that a process of confirming whether or not the operation request exists is provided, so that when the operation request for the communication control part 13 does not exist, the procedure can proceed to step S73.

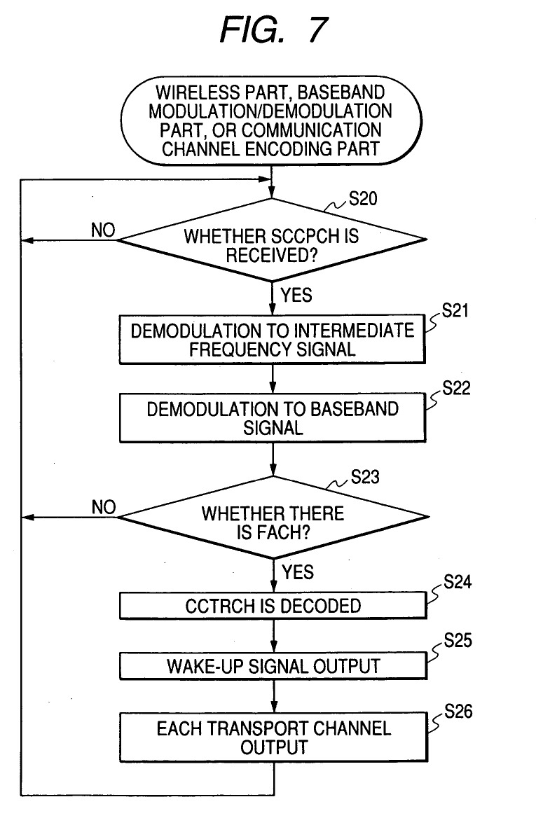

Next, in this embodiment 1, a specific operation of the wireless part 3, the baseband modulation/demodulation part 6 or the communication channel encoding part 9 in the case where the mobile station 1 waits for the FACH will be described on the basis of FIG. 7.

Step S20 is a process in which the wireless part 3 waits for the SCCPCH as a high frequency signal.

Step S21 is a process in which in the case where the SCCPCH as the high frequency signal is inputted to the down converter 5, the SCCPCH is demodulated from the high frequency signal to an intermediate frequency signal.

Step S22 is a process in which in the case where the SCCPCH as the intermediate frequency signal is inputted to the baseband modulation/demodulation part 8, the SCCPCH is demodulated from the intermediate frequency signal to a baseband signal.

A transport channel included in the baseband signal demodulated at step S2.2 is a CCTRCH.

Step S23 is a process in which by using the desired channel existence judgment part 12, it is judged whether or not the FACH exists in the SCCPCH demodulated into the baseband signal at step S22.

Since the desired channel existence judgment part 12 can judge whether or not a desired transport channel is included in the CCTRCH, it is possible to judge whether or not the FACH is included in the SCCPCH demodulated at step S22. In the case where the judgment result indicates that the desired transport channel is included in the CCTRCH, a signal indicating that the FACH exists in the SCCPCH is outputted.

Incidentally, the judgment here is performed by using a TFCI (Transport Format Combination Indicator) included in the CCTRCH.

In the case where the judgment result of step S23 indicates that the FACH exists in the CCTRCH, the procedure proceeds to step S24. On the other hand, in the case where the judgment result of step S23 indicates that the FACH does not exist in the CCTRCH, the procedure returns to step S20, and the wireless part 3 again waits for the SCCPCH as the high frequency signal.

Step S24 is a process in which the communication channel encoding part 9 uses the TFCI to separate the CCTRCH into plural transport channel signals and decodes them.

Step S25 is a process in which in the case where the decoding of the CCTRCH is completed, a wake-up signal is transmitted to the communication control part 13. It is desirable that the wake-up signal is an interrupt signal. This is because the communication control part 13 is not only in a state in which the power source is shut off, but also in a state in which an operation program different from a reception operation is carried out.

Step S26 is a step in which after the wake-up signal is outputted to the communication control part 13 at step S25, a signal of each transport channel is outputted from the communication channel encoding part 9 to the communication control part 13. After the signal of each transport channel is outputted to the communication control part 13, the procedure returns to step S20, and the wireless part 3 again waits for the SCCPCH as the high frequency signal.

In the operation described in FIG. 7, the judgment process using the TFCI exists at the former stage of the process of decoding the CCTRCH. The reason is that the communication channel encoding part performs the processing using the TFCI before decoding the CCTRCH, and the processing using the TFCI can be performed more efficiently. Accordingly, even if the judgment using the TFCI is performed after the CCTRCH is decoded, in the case where the mobile station 1 waits for the FACH, the object to save the electric power consumed by the mobile station 1 can be achieved.

Besides, in order that a time when the communication control part 13 is in the power ON state becomes as short as possible, the communication channel encoding part 9 outputs the wake-up signal when the decoding of the CCTRCH is completed. However, in order to intermittently operate the communication control part 13, the wake-up signal may be outputted from any portion of the wireless part 3, the baseband modulation/demodulation part 6 and the communication channel encoding part 9. Besides, the timing when the wake-up signal is outputted may be any timing in a period from a time when the high frequency signal is inputted to the wireless part 3 to a time when the decoding of the CCTRCH is completed.

According to the embodiment, in the case where the mobile station 1 waits for the FACH, the electric power consumption of the communication control part 13 is saved, so that the wireless signal receiving method can be realized in which the electric power consumption of the mobile station 1 is saved.

Besides, in the case where the CCTRCH is decoded using the TFCI, it is judged by using the TFCI whether or not the FACH exists in the SCCPCH, so that the wireless signal receiving method with excellent use efficiency of apparatus resource can be realized.

Besides, in the case where the judgment result indicates the existence of the FACH, and when the CCTRCH is decoded, the power source of the communication control part 13 is brought into the ON state by the interrupt signal, so that the wireless signal receiving method can be expressed in which the electric power consumption is further saved.

Besides, since the sleep process includes the confirmation process, the wireless signal receiving method can be realized in which the communication control part is not stopped in the case where the communication control part needs to be operated.

Besides, in the case where the mobile station 1 waits for the FACH, the electric power consumption of the communication control part 13 is saved, so that the wireless signal receiving apparatus can be realized in which the electric power consumption is saved.

Besides, in the case where the CCTRCH is decoded using the TFCI, the TFCI is used to judge whether or not the FACH exists in the SCCPCH, so that the wireless signal receiving apparatus with excellent use efficiency of apparatus resource can be realized.

Besides, in the case where the judgment result indicates the existence of the FACH, and when the CCTRCH is decoded, the power source of the communication control part 13 is brought into the ON state by the interrupt signal, so that the wireless signal receiving apparatus can be realized in which the electric power consumption is further saved.

Besides, since the sleep process includes the confirmation process, the wireless signal receiving apparatus can be realized in which the communication control part is not stopped in the case where the communication control part needs to be operated.

### Embodiment 2

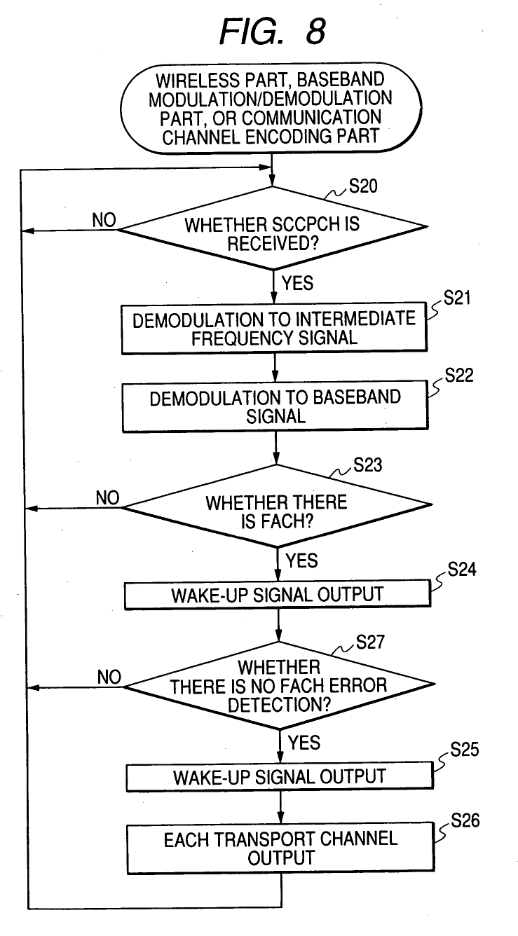

In this embodiment 2, on the basis of FIG. 8, a description will be given to a specific operation of the wireless part 3, the baseband modulation/demodulation part 6 or the communication channel encoding part 9 at the time when a reception error of a received FACH is detected by making a CRC (Cyclic Reducdancy Check) judgment after the existence of the FACH with respect to the CCTRCH included in the SCCPCH is judged by the TFCI in the case where the mobile station 1 waits for the FACH.

Incidentally, a step similar to that of embodiment 1 is denoted by the same symbol as that of embodiment 1 and its description will be omitted.

Step S27 is an error detection process in which after the CCTRCH is decoded at step S24, it is detected whether or not reception of respective transport channels multiplexed in the CCTRCH is erroneous.

In this process, the CRC judgment is made for each received transport channel. The CRC judgment is the judgment in which it is outputted whether or not the transport channel as the judgment object is normally received.

In the case where all the transport channels multiplexed in the CCTRCH are abnormal according to the CRC judgment, even if the FACH is included in the transport channels, it is meaningless to decrypt the FACH.

Accordingly, in such a case, a wake-up signal is not outputted to the communication control part 13. Then, since the timing when the communication control part 13 wakes up becomes a time when the FACH is received next, a time in which the communication control part 13 is made to sleep becomes long, and the electric power consumed by the communication control part 13 is further saved. Since other processes are similar to those of embodiment 1, their description will be omitted.

According to embodiment 2 as described above, since it is possible to judge, after the CRC judgment, whether or not the communication control part 13 should be waked up, the communication control part 13 are not unnecessarily waked up, and the wireless communication control apparatus can be realized in which the electric power consumption of the communication control part 13 is further saved.

Besides, since it is possible to judge, after the CRC judgment, whether or not the communication control part 13 should be waked up, the communication control part 13 is not unnecessarily waked up, and the method of further saving the electric power consumption of the communication control part 13 can be realized.

### Embodiment 3

In embodiment 3, a method of waiting for a FACH during packet switched will be described.

During the packet switched service, according to the traffic volume transmitted between the base station 0 and the mobile station 1, the mobile station 1 suitably switches between an dedicated state and a common state.

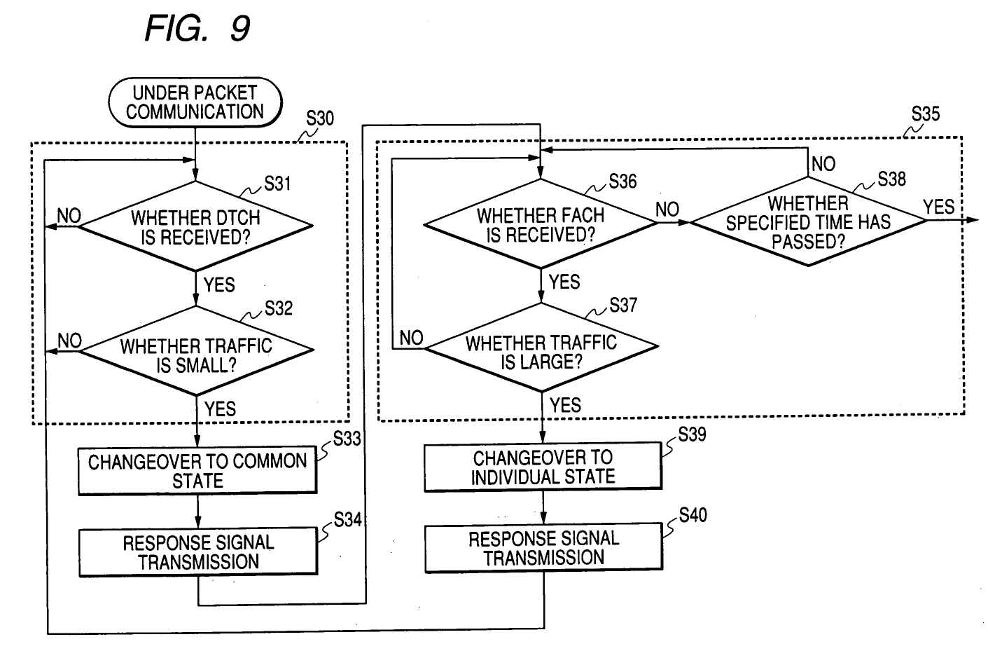

The operation of the mobile station 1 during the packet switched service will be described on the basis of FIG. 9.

Step S30 is a process of the mobile station 1 in the case where the mobile station 1 is in the dedicated state and roughly includes step S31 and step S32.

Step S31 is a process in which it is confirmed whether or not the mobile station 1 receives a DTCH (Dedicated Traffic Channel). At step S31, in the case where the mobile station 1 receives a logical channel other than the DTCH, it waits for the DTCH again.

At step S32, in the case where the DTCH is received, the signal is processed. In the case where the DTCH is information to notify the traffic volume transmitted between the base station 0 and the mobile station 1, it is a process in which it is judged whether or not the traffic volume transmitted between the base station 0 and the mobile station 1 is smaller than a specified amount.

In the case where the judgment result indicates that the traffic volume transmitted between the base station 0 and the mobile station 1 is equal to or smaller than the specified amount, it is determined that the state of the mobile station 1 is switched to the common channel, and the procedure proceeds to step S33.

In the case where the judgment result indicates that the traffic volume transmitted between the base station 0 and the mobile station 1 is larger than the specified amount, the mobile station 1 continues the dedicated state, and again waits for the reception of the DTCH.

Step S33 is a process in which after step S32, the mobile station 1 switches the state of the mobile station 1 from the dedicated state to the common state.

Step S34 is a process of notifying the base station 0 that the state of the mobile station 1 is switched from the dedicated state to the common state.

Step S35 is a process in the case where the state of the mobile station 1 is in the common state, and includes step S36, step S37 and step S38.

Step S36 is a process in which the mobile station 1 waits for the FACH. Information contained in the FACH during the packet switched service is a control signal or a meaningful signal of characters, images, moving pictures or the like. Incidentally, there is a case where the signal received by the mobile station 1 as the control signal includes a signal indicating whether or not the traffic volume transmitted between the base station 0 and the mobile station 1 is large.

Step S37 is a process in which together with step S36, in the common state, it is periodically judged whether or not the traffic volume transmitted between the base station 0 and the mobile station 1 is large.

In the drawing, although it is provided at the latter stage of step S36, it may be performed at any time as long as the power source of the communication control part 13 is in the ON state.

Step S38 is a process in which in the case where the FACH is not received, it is judged whether or not the state in which the FACH is not received exceeds a specified time. In general, in the case where the state in which the mobile station 1 does not receive the FACH exceeds the specified time, the mobile station 1 ends the packet switched service state, and switches the state of the mobile station 1 from the common state to the waiting state.

Accordingly, even in the case where the mobile station 1 is in the common state and does not receive the FACH, the packet switched service state continues until the specified time elapses. When the FACH is received before the specified time elapses, the packet switched service state continues until the specified time elapses again.

For example, after the mobile station 1 receives a mail, until the specified time elapses, the packet switched service state in the common state continues, and the FACH is waited. Besides, after the mobile station 1 receives a meaningful signal of characters, images or the like from a Website or the like, until the specified time elapses, the state in which the FACH is waited continues.

Besides, there is a case where an operator performs an action (hereinafter referred to as an “intermittent browsing action”) of repeating such an operation that the mobile station 1 is used, and for example, like an action called net surfing, after a Website is downloaded, the Website is browsed, and after the browsing, another Website is downloaded, and the Website is browsed.

In this case, after the meaningful signal of characters, images or the like is received, the state in which the FACH is waited continues for the specified time. Besides, after the meaningful signal of characters, images or the like is again received, the state of waiting for the FACH continues for the specified time.

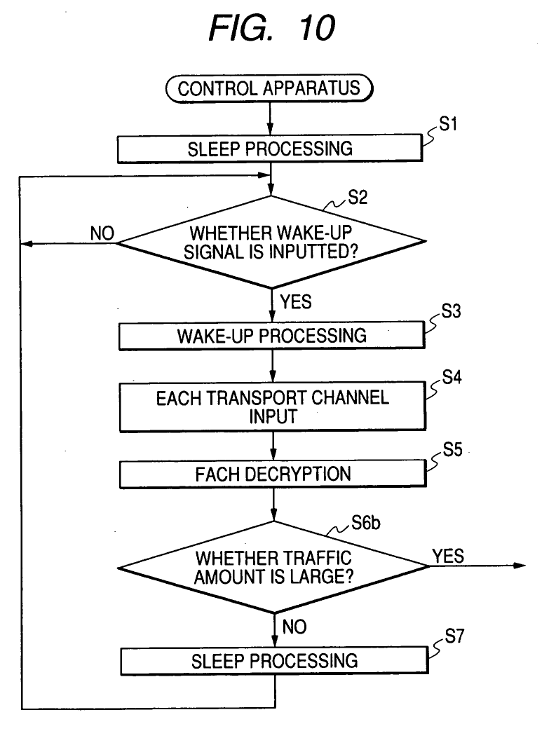

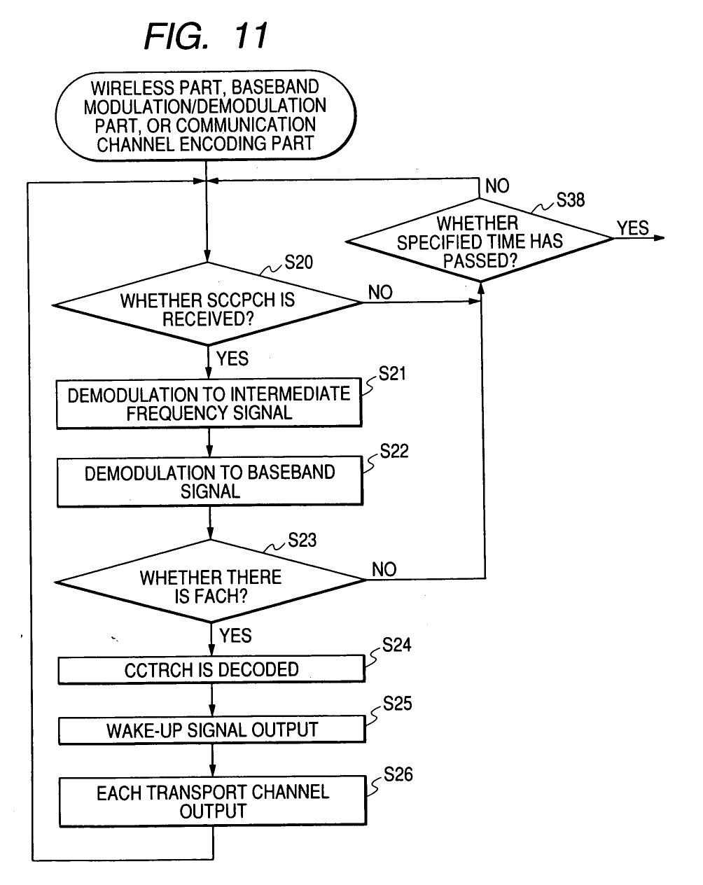

A specific operation in step S35 is performed on the basis of FIGS. 10 and 11.

In FIG. 10, step S6b is provided instead of step S6a of FIG. 5. Step S6b is a process in which the traffic volume transmitted between the mobile station 1 and the base station 0 is periodically grasped, and as a result of the grasp, it is judged whether or not the communication state is switched according to the traffic volume.

In the drawing, although being provided at the latter stage of step S5, step S6b may be performed at any time as long as the power source of the communication control part 13 is in the ON state.

In the case where step S6b exists at the latter stage of step S5, step S7 is performed after step S6b. In the case where step S6b is performed at a stage other than the latter stage of step S5, step S7 is performed at the latter stage of step S5.

FIG. 11 is a flowchart similar to FIG. 7. However, it is different from FIG. 7 in that step S38 of FIG. 9 intervenes between the latter stage of step S20 and step S23 and the former stage of step S20.

According to embodiment 3 as described above, in the case where the packet switched service is performed in the common state, since the electric power consumption of the communication control part 13 can be saved, the wireless signal receiving method can be realized in which after mail reception performed by using the packet switched service, electric power consumed by the mobile station 1 is saved.

Besides, the wireless signal receiving method can be realized in which after browsing of a Website, electric power consumed by the mobile station 1 is saved.

Besides, the wireless signal receiving method can be realized in which in the case where the intermittent browsing action is performed using the mobile station 1, the electric power consumption of the mobile station 1 is saved.

Besides, the wireless signal receiving apparatus can be realized in which after the mail reception performed by using the packet switched service, electric power consumption is saved.

Besides, the wireless signal receiving apparatus can be realized in which after browsing of a Website, electric power consumption is saved.

Besides, the wireless signal receiving apparatus can be realized in which electric power consumption is saved in the case where intermittent browsing action is performed.

### Embodiment 4

Embodiment 4 is a method of saving the electric power of the communication control part 13 in the case of waiting for a DTCH (Dedicated Traffic Channel).

Among specific channels used in the WCDMA system, channels used in this embodiment 4 will be described.

A DPCH (Dedicated Physical Channel) is one of physical channels, and is one of individual channels. Besides, the DPCH is a channel sent at an unspecified time.

A DCH (Dedicated Channel) is one of traffic channels, and is one of individual channels. Besides, the DCH is a channel mapped to the DPCH. Besides, it is an up or down bidirectional channel.

A DTCH is one of logical channels. Besides, it is one of individual channels. Besides, the DTCH is a channel mapped to the DCH or the like. Besides, the DTCH is a channel which can be transmitted from the base station 0 to the mobile station 1 in order to indicate the traffic volume transmitted between the base station 0 and the mobile station 1.

The DTCH is a channel included in the DPCH, and the DPCH is a channel sent from the base station 0 to the mobile station 1 at an unspecified time. Accordingly, similarly to the method of waiting for the FACH included in the SCCPCH, also in the method of waiting for the DTCH, the electric power consumption of the communication control part 13 can be saved. The DTCH is waited at, for example, step S30 in FIG. 9.

Besides, with respect to a specific operation of step S30 of FIG. 9, in principle, in the operation shown in FIGS. 6 to 10, the SCCPCH has only to be replaced by the DPCH, and the FACH has only to be replaced by the DTCH. However, in the case of waiting for the DTCH, the mobile station 1 is switched to the common state in the case where the traffic volume transmitted between the base station 0 and the mobile station 1 is equal to or smaller than the specified amount. Thus, instead of the process of step S6b in FIG. 10, it is necessary to provide step S6c (not shown) of judging whether or not the traffic volume is small.

When the method of waiting for the DTCH and the method of waiting for the FACH are combined and used, the electric power consumed by the mobile station 1 during the packet switched service can be further saved.

According to the above embodiment, the wireless signal receiving method can be realized in which in the case of waiting for the DTCH, the electric power consumption of the communication control part 13 is saved.

Besides, the wireless signal receiving method with excellent use efficiency of apparatus resource can be realized by using, in the case where the CCTRCH is decoded using the TFCI, the TFCI to judge whether or not the DTCH exists in the DPCH.

Besides, in the case where the CCTRCH is decoded using the signal used for the CRC judgment, since it is judged by using the signal used for the CRC judgment whether or not the DTCH exists in the DPCH, the wireless signal receiving method with excellent use efficiency of apparatus resource can be realized.

Besides, in the case where the judgment result indicates the existence of the DTCH, and when the CCTRCH is decoded, the power source of the communication control part 13 is brought into the ON state by the interrupt signal, so that the wireless signal receiving method can be realized in which the electric power consumption is further saved.

Besides, since the sleep process includes the confirmation process, the wireless signal receiving method can be realized in which the communication control part is not stopped in the case where the communication control part needs to be operated.

Besides, the wireless signal receiving method can be realized in which the electric power consumption of the communication control part 13 is saved in the case of waiting for the DTCH.

Besides, in the case of waiting for the DTCH, the electric power consumption of the communication control part 13 is reduced, so that the wireless signal receiving method can be realized in which the electric power consumption used during the packet switched service is reduced.

Besides, the wireless signal receiving apparatus can be realized in which the electric power consumption of communication control part 13 is saved in the case of waiting for the DTCH.

Besides, in the case where the CCTRCH is decoded using the TFCI, the TFCI is used to judge whether or not the DTCH exists in the DPCH, so that the wireless signal receiving apparatus with excellent use efficiency of apparatus resource can be realized.

Besides, since it is possible to judge, after the CRC judgment, whether or not the communication control part 13 should be waked up, the communication control part 13 is not unnecessarily waked up, and the wireless control apparatus can be realized in which the electric power consumption of the communication control part 13 is further saved.

Besides, in the case where the judgment result indicates the existence of the DTCH, and when the CCTRCH is decoded, the power source of the communication control part 13 is brought into the ON state by the interrupt signal, so that the wireless signal receiving apparatus can be realized in which the electric power consumption is further saved.

Besides, since the sleep process includes the confirmation process, the wireless signal receiving apparatus can be realized in which the communication control part is not stopped in the case where the communication control part needs to be operated.

Besides, in the case of waiting for the DTCH, the wireless signal receiving apparatus can be realized in which the electric power consumption of the communication control part 13 is saved.

Besides, in the case of waiting for the DTCH, the electric power consumption of the communication control part 13 is reduced, so that the wireless signal receiving apparatus can be realized in which the electric power consumption used during the packet switched service is reduced.

### INDUSTRIAL APPLICABILITY

This invention is used in, for example, a mobile terminal in the WCDMA system.

1-14. (canceled)

15. A wireless signal receiving method in which after a physical channel sent from a base station in a wireless communication system at an unspecified timing is demodulated from a high frequency signal to a baseband signal, the baseband signal is decoded and is output as a decoded baseband signal, and
a desired channel included in the decoded baseband signal is decrypted by a communication control part for performing communication control, the wireless communication receiving method comprising:
judging whether or not the desired channel exists in the physical channel of the decoded baseband signal and outputting a judgment result;
waking-up of bringing a power source of the communication control part into an ON state in a case in which the judgment result indicates existence of the desired channel; and
sleeping of bringing the power source of the communication control part into an OFF state when it is confirmed that the communication control part does not need to be operated in a case in which the power source of the communication control part is in the ON state.

16. A wireless signal receiving method as recited in claim 15, wherein the wireless communication system is a WCDMA system, the physical channel is a SCCPCH, and the desired channel is an FACH.

17. A wireless signal receiving method as recited in claim 16, wherein the judging is performed using a TFCI decoded by the decoding part.

18. A wireless signal receiving method as recited in claim 16, wherein after the judging, error detection of the judgment result is performed.

19. A wireless signal receiving method as recited in claim 18, wherein the error detection is made by a CRC judgment.

20. A wireless signal receiving method as recited in claim 16, wherein at the waking-up, in a case in which the judgment result indicates the existence of the FACH, and when the SCCPCH is decoded, the power source of the communication control part is brought into the ON state by an interrupt signal.

21. A wireless signal receiving method as recited in claim 15, wherein the wireless communication system is a WCDMA system, the physical channel is a DPCH, and the desired channel is a DTCH.

22. A wireless signal receiving method as recited in claim 21, wherein the judging is performed using a TFCI decoded by the decoding part.

23. A wireless signal receiving method as recited in claim 21, wherein after the judging, error detection of the judgment result is performed.

24. A wireless signal receiving method as recited in claim 23, wherein the error detection is made by a CRC judgment.

25. A wireless signal receiving method as recited in claim 21, wherein at the waking-up, in a case in which the judgment result indicates the existence of the DTCH, and when the DPCH is decoded, the power source of the communication control part is brought into the ON state by an interrupt signal.

26. A wireless signal receiving method as recited in claim 15, wherein the sleeping includes:
confirming whether or not an operation instruction to the communication control part exists in a case in which a decryption result of the communication control part indicates continuation of reception of the desired channel signal, and
power supply stop processing of bringing the power source of the communication control part into an OFF state in a case in which the confirming indicates that there is no operation instruction.

27. A wireless signal receiving method as recited in claim 16, wherein the confirming confirms one of whether or not there is a processing request from various terminals connected to the communication control part, whether or not information acquisition of a peripheral cell is necessary, and whether or not the information acquisition of the peripheral cell exists.

28. A wireless signal receiving apparatus in a wireless signal receiving method in which after a physical channel sent from a base station in a wireless communication system at an unspecified timing is demodulated from a high frequency signal to a baseband signal, the baseband signal is decoded and is output as a decoded baseband signal, and
a desired channel included in the decoded baseband signal is decrypted by a communication control part for performing communication control,
the apparatus comprising:
means for judging whether or not a signal of the desired channel exists in the physical channel of the decoded baseband signal and outputting a judgment result;
means for bringing a power source of the communication control part into an ON state in a case in which the judgment result indicates existence of the desired channel; and
means for bringing the power source of the communication control part into an OFF state when it is confirmed that the communication control part does not need to be operated in a case in which the power source of the communication control part is in the ON state.
